(19) United States
(12) Patent Application Publication
(10) Pub. No.: US 2002/0145553 A1
(43) Pub. Date: Oct. 10, 2002

(54) Remote controller with a function display unit for visual indication of a selected control function

(76) Inventor: Apin Chang, Chung-Ho City (TW)

Correspondence Address: TROP PRUNER & HU, PC, 8554 KATY FREEWAY, SUITE 100, HOUSTON, TX, 77024, US

(21) Appl. No.: 09/851,924

(22) Filed: May 9, 2001

(30) Foreign Application Priority Data
Apr. 6, 2001 (TW) 090205364

(51) Int. Cl. H04Q 1/00; H04B 1/00; H04B 1/38; G08C 19/12

(52) U.S. Cl. 341/175; 340/5.64

(57) ABSTRACT

A remote controller is capable of transmitting different control signals for controlling an anti-theft device on an automobile, and includes a controller circuit disposed in a casing, and a function key set and a function display unit mounted on the casing and connected electrically to the controller circuit. The controller circuit includes a processor unit and a transmitter circuit connected electrically to and controlled by the processor unit so as to transmit the control signals wirelessly. The function key set includes a function select key operable so as to control selection of the control signals by the processor unit. The function display unit is controlled by the processor unit to provide a visual indication corresponding to a currently selected one of the control signals.

### BACKGROUND OF THE INVENTION

1. Field of the Invention

The invention relates to a device for remote control, more particularly to a remote controller for automobiles that facilitates selection of a desired control function.

2. Description of the Related Art

Automobiles are generally provided with an anti-theft device that can be operated in an activated state for generating an alarm signal in the event of theft. The anti-theft device is also operable so as to lock or unlock automobile doors, and so as to generate an output to facilitate searching for an automobile that is installed with the anti-theft device. Operation of the anti-theft device is generally controlled through a remote controller. Particularly, when a lock or unlock key on the remote controller is pressed, the anti-theft device locks or unlocks the automobile doors, and simultaneously operates in the activated or deactivated state.

A conventional remote controller for automobiles generally includes at least three function keys, which are defined with three different control functions, respectively. In addition, the function keys can be operated simultaneously in pairs to result in three other pre-defined control functions. To aid users in memorizing the available control functions and their associated key combinations, manufacturers generally provide the remote controllers with an appropriate look-up table guide. However, as the number of the available control functions increases, the likelihood of confusion increases as well because the available control functions and the actual number of keys on the remote controller have a many-to-one relationship. Therefore, the user has to rely heavily on the look-up table guide to be able to operate the conventional remote controller properly.

### SUMMARY OF THE INVENTION

Therefore, the main object of the present invention is to provide a remote controller that is capable of transmitting different control signals for controlling an anti-theft device on an automobile and that has a function display unit for visual indication of a currently selected control function to facilitate selection of the latter.

According to the present invention, a remote controller is capable of transmitting different control signals for controlling an anti-theft device on an automobile, and comprises:

a casing;

a controller circuit disposed in the casing and including a processor unit and a transmitter circuit connected electrically to and controlled by the processor unit so as to transmit the control signals wirelessly;

a function key set mounted on the casing and connected electrically to the processor unit, the function key set including a function select key operable so as to control selection of the control signals by the processor unit; and

a function display unit mounted on the casing and connected electrically to the processor unit, the function display unit being controlled by the processor unit to provide a visual indication corresponding to a currently selected one of the control signals.

Preferably, the function key set further includes a command transmit key operable so as to enable the processor unit to control the transmitter circuit to transmit the currently selected one of the control signals.

In one embodiment, the function display unit includes: a plurality of lamp units, each of which corresponds to a respective one of the control signals and is activated by the processor unit when the respective one of the control signals is currently selected by the processor unit; and a plurality of patterns, each of which is disposed adjacent to a respective one of the lamp units and illustrates a control function associated with the respective one of the control signals.

In another embodiment, the function display unit includes a liquid crystal display for showing a plurality of function icons thereon, each of the function icons illustrating a control function associated with a respective one of the control signals, and being highlighted when the respective one of the control signals is currently selected by the processor unit.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing the first preferred embodiment of a remote controller according to the present invention;

FIG. 2 is a schematic circuit block diagram showing a controller circuit of the first preferred embodiment;

FIG. 3 is a schematic view of a function display unit of the first preferred embodiment; and

FIGS. 4 and 5 are schematic views showing a function display unit of the second preferred embodiment of a remote controller according to the present invention.

### DETAILED DESCRIPTION OF THE PREFERRED EMBODIMENTS

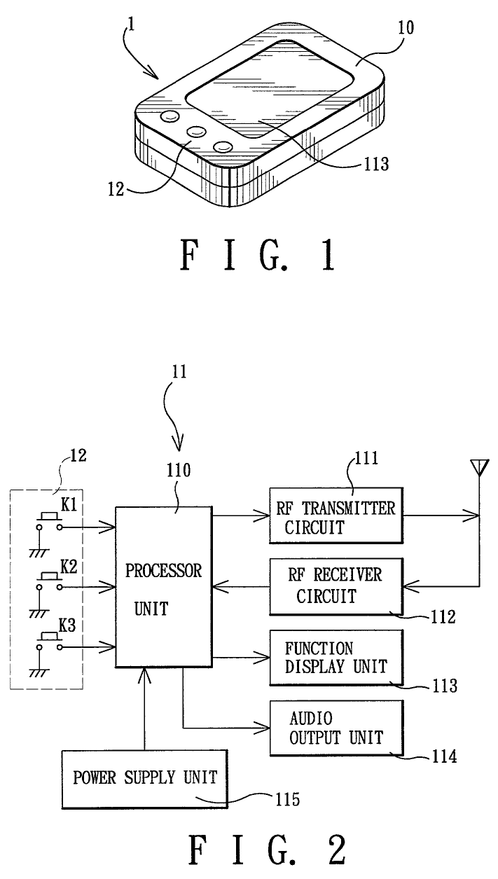

Referring to FIGS. 1 and 2, the first preferred embodiment of a remote controller 1 according to the present invention is adapted to be used for transmitting different control signals to control the operation of an anti-theft device (not shown) on an automobile (not shown) . The remote controller 1 comprises a casing 10 and a circuit board (not shown) disposed in the casing 10. A controller circuit 11 is disposed on the circuit board. A function key set 12 is mounted on the casing 10 and is connected electrically to the controller circuit 11. A function display unit 113 is also mounted on the casing 10 and is connected electrically to the controller circuit 11. The function key set 12 includes first and second command transmit keys (K1, K2), and a function select key (K3) . The controller circuit 11 includes a processor unit 110, a radio frequency (RF) transmitter circuit 111, a RF receiver circuit 112, an audio output unit 114, and a power supply unit 115. The processor unit 110 is connected electrically to the function key set 12, the transmitter circuit 111, the receiver circuit 112, the function display unit 113, the audio output unit 114 and the power supply unit 115. The processor unit 110 receives input key signals from the function key set 12. Based on the input key signals, the processor unit 110 controls the transmitter circuit 111 to transmit the control signals wirelessly. The receiver circuit 112 is adapted to receive acknowledge or alarm signals from the anti-theft device and to provide the same to the processor unit 110 in a known manner. The function display unit 113 is controlled by the processor unit 110 to provide a visual indication corresponding to one of the control signals currently selected by the processor unit 110. The audio output unit 114, such as a buzzer, is controlled by the processor unit 110 to generate an audible output whenever one of the control signals is selected by the processor unit 110. The power supply unit 115 supplies electric power to the processor unit 110.

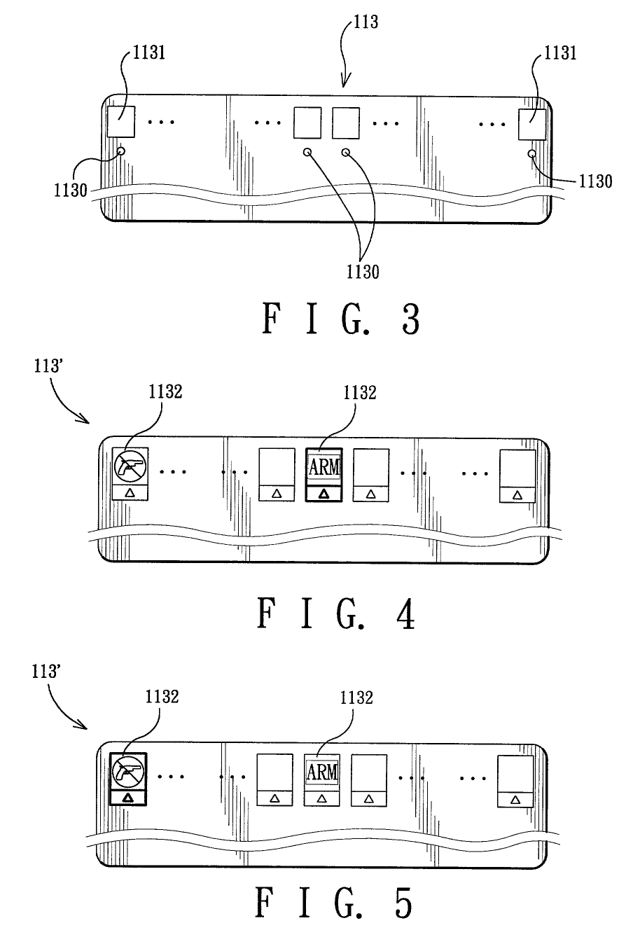

With further reference to FIG. 3, in this embodiment, the function display unit 113 includes a plurality of lamp units 1130, and a plurality of patterns 1131 disposed adjacent to the lamp units 1130, respectively. The lamp units 1130 are preferably light emitting diodes, and correspond respectively to the control signals. The patterns 1131 may be in text or graphic form. Each of the patterns 1131 is used to illustrate a control function associated with the respective one of the control signals. Whenever the function select key (K3) is operated, the processor unit 110 will be enabled to select the control signals sequentially, and will activate the lamp unit 1130 corresponding to the selected one of the control signals accordingly. After selection of the desired control signal, the first command transmit key (K1) is operated so as to enable the processor unit 110 to activate the transmitter circuit 111 so that the currently selected one of the control signals can be transmitted wirelessly for reception by the anti-theft device. The second command transmit key (K2) is configured in a manner similar to a hot key of a computer. Particularly, when the second command transmit key (K2) is operated, the processor unit 110 will activate the transmitter circuit 111 so that a predetermined one of the control signals, such as a lock or unlock control signal, will be transmitted wirelessly. Preferably, whenever one of the control signals is selected, the processor unit 110 further controls the audio output unit 114 to generate an audio output. More preferably, the audio outputs generated by the audio output unit 114 vary for the different control signals.

Referring to FIG. 4, the function display unit 113′ of the second preferred embodiment of a remote controller according to the present invention is shown to include a liquid crystal display that is configured as a graphic interface for showing a plurality of function icons 1132 thereon. Each of the function icons 1132 is used to illustrate a control function associated with a respective one of the control signals, and is highlighted when the respective one of the control signals is currently selected by the processor unit 110 (see FIG. 2). The selection operation of the processor unit 110 proceeds in a manner similar to that of the previous embodiment with the use of the function select key (K3) (see FIG. 2). In FIG. 4, the lock-arming control function is selected, and the corresponding function icon 1132 is highlighted accordingly. The lock-arming control signal is transmitted when the first command transmit key (K1) is operated. In FIG. 5, the function select key (K3) is operated repeatedly from the state shown in FIG. 4 until the function icon 1132 corresponding to the anti-theft control function is highlighted. Operation of the first command transmit key (K1) at this time will result in transmission of the anti-theft control signal. Like the previous embodiment, whenever one of the control signals is selected, the processor unit 110 further controls the audio output unit 114 to generate an audio output. More preferably, the audio outputs generated by the audio output unit 114 vary for the different control signals.

It has thus been shown that the function display unit on the remote controller of this invention makes the latter very convenient to use since selection of desired control functions is possible without the need to memorize key combinations. The object of the invention is thus met.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A remote controller capable of transmitting different control signals for controlling an anti-theft device on an automobile, said remote controller comprising:
a casing;
a controller circuit disposed in said casing and including a processor unit and a transmitter circuit connected electrically to and controlled by said processor unit so as to transmit the control signals wirelessly;
a function key set mounted on said casing and connected electrically to said processor unit, said function key set including a function select key operable so as to control selection of the control signals by said processor unit; and
a function display unit mounted on said casing and connected electrically to said processor unit, said function display unit being controlled by said processor unit to provide a visual indication corresponding to a currently selected one of the control signals.

2. The remote controller as claimed in claim 1, wherein said function key set further includes a first command transmit key operable so as to enable said processor unit to control said transmitter circuit to transmit the currently selected one of the control signals.

3. The remote controller as claimed in claim 2, wherein said function key set further includes a second command transmit key operable so as to enable said processor unit to control said transmitter circuit to transmit a predetermined one of the control signals.

4. The remote controller as claimed in claim 1, wherein said function display unit includes:
a plurality of lamp units, each of which corresponds to a respective one of the control signals and is activated by said processor unit when the respective one of the control signals is currently selected by said processor unit; and
a plurality of patterns, each of which is disposed adjacent to a respective one of said lamp units and illustrates a control function associated with the respective one of the control signals.

5. The remote controller as claimed in claim 1, wherein said function display unit includes a liquid crystal display for showing a plurality of function icons thereon, each of said function icons illustrating a control function associated with a respective one of the control signals, and being highlighted when the respective one of the control signals is currently selected by said processor unit.

6. The remote controller as claimed in claim 1, wherein said controller circuit further includes an audio output unit connected to and controlled by said processor unit so as to generate an audio output whenever one of the control signals is selected by said processor unit.
